(19) United States
(12) Patent Application Publication
(10) Pub. No.: US 2014/0303940 A1
(43) Pub. Date: Oct. 9, 2014

(54) SYSTEMS AND METHODS FOR CONSERVATION MEASURES

(71) Applicant: Sefaira, Inc., New York, NY (US)

(72) Inventors: JOSHUA KATES, London (GB); Alexander Marshall, Little Wymondley (GB); Simon Sawada, London (GB); Varun Singh, New York, NY (US); Mads Jensen, London (GB)

(21) Appl. No.: 14/025,691

(22) Filed: Sep. 12, 2013

Related U.S. Application Data
(60) Provisional application No. 61/809,812, filed on Apr. 8, 2013.

(51) Int. Cl. G06F 17/50

(52) U.S. Cl. CPC G06F 17/5004
USPC 703/1

(57) ABSTRACT

Various embodiments provide systems and methods that can be configured to analyze implementing one or more conservation measures (CMs) to an architectural structure, which can include proposing one or more sequences for implementing the conservation measures. Some embodiments may assist in identifying which conservation measures to implement, determining benefits of implementing selected conservation measures, or planning implementation of selected conservation measures. Those conservation measures selected for implementation may be part of a retrofit plan intended for an architectural structure to improve utility usage by that architectural structure. Accordingly, certain embodiments can help in assessing risks of a retrofit plan, or determining the time, scope, budget, or quality of the retrofit plan.

### CROSS-REFERENCE TO RELATED APPLICATIONS

This application claims the benefit of U.S. Provisional Patent Application Ser. No. 61/809,812, filed Apr. 8, 2013, entitled “SYSTEMS AND METHODS FOR CONSERVATION MEASURES,” which is hereby incorporated herein by reference.

### TECHNICAL FIELD

The technology disclosed herein relates to conservation planning, and more particularly, some embodiments relate to systems and methods for planning implementation of conservation measures in an architectural structure.

### DESCRIPTION OF RELATED ART

When designing new architectural structures or retrofitting existing ones, designers often consider and analyze how much energy, water, fuel and other resources are being or going to be consumed by the architectural structure after it has been is constructed/retrofitted. Designers often attempt to optimize their design or retrofit plans for optimal resource consumption (e.g., energy, water, materials, etc.), lower implementation costs, lower operational costs, and lower maintenance costs. In addition to lowering overall costs and resource uses, an optimized design may also improve a structure's compliance with building standards, certifications and ratings. These standards, certifications and ratings include green building certification and rating systems, such as Leadership in Energy & Environmental Design (LEED®), Code for Sustainable Homes (CSH), and Estidama, and environmental impact rating systems, such as Building Research Establishment Environment Assessment Method (BREEAM), and Building and Construction Authority (BCA) GreenMark.

While creating their design or retrofit plan for an architectural structure, designers also consider budgetary constraints, particularly where implementation of a plan is to occur in multiple stages over time (e.g., months or years). Take for example a plan to retrofit an existing architectural structure with a number of conservation measures (e.g., energy, water, or fuel conservation measures) over a period of 10 years. The designer creating such a plan may need to consider capital expenditure limits for each of the 10 years of the plan, and may need to sequence the implementation of the conservation measures according to those yearly limits to meet budgetary constraints.

### BRIEF SUMMARY OF EMBODIMENTS

Various embodiments provide systems and methods that can be configured to analyze implementing one or more conservation measures (CMs) to an architectural structure (e.g., office buildings, bridges, parking structures, shopping centers, etc.), which can include proposing one or more sequences for implementing the conservation measures. As described herein, a “conservation measure” can include an action, feature, or modification taken with respect to an architectural structure in order to reduce or alter usage or cost associated with a utility or other service and the architectural structure. For instance, a given conservation measure may reduce energy use, energy costs, water usage, water costs, carbon output, utility maintenance costs, or utility operational costs. An energy conservation measure (ECM) as applied to an architectural structure can involve modification of a component or feature of the architectural structure that results in energy savings by the architectural structure.

According to various embodiments of the disclosed technology, systems and methods can identify permutations of a set of candidate conservation measures (e.g., ECMs) for an architectural structure, wherein each of the permutations proposes a sequence for implementing the set of candidate conservation measures to the architectural structure. The set of candidate conservation measures may include those selected by a user for consideration for implementation to the architectural structure, and selected by the user to determine a desirable sequence for implementing the set of candidate conservation measures.

The systems and methods can then analyze implementation of the set of candidate conservation measures according to a particular sequence proposed by at least one of the permutations identified. The systems and methods can then determine a proposed sequence for implementing the set of candidate conservation measures to the architectural structure, wherein the proposed sequence is determined based at least on analyzing implementation of the set of candidate conservation measures according to the particular sequence. Analyzing implementation of the set of candidate conservation measures can be based on conservation measure data. Additionally, analyzing implementation of the set of candidate conservation measures can be based on a constraint. Eventually, the systems and methods can present the proposed sequence for implementing the set of candidate conservation measures to the architectural structure.

The proposed sequence may be one that allows for implementation of the candidate conservation measures within a set of constraints, such as duration of implementation or cash flow limitations. Additional examples of constraints can include specifics regarding the architectural structure, duration of the retrofit plan, maximum capital expenditure per a given time period, incentives for implementations, and those associated with implementation of two or more conservation measures in a given time period (e.g., CM₁ and CM₂ cannot be implemented in the same year).

In some embodiments, the systems and methods can receive conservation measure data for analyzing implementation of the set of candidate conservation measures. Additionally, in some embodiments, the systems and methods can receive a constraint for analyzing implementation of the set of candidate conservation measures.

In certain embodiments, the systems and methods can determine an initial sequence for implementing the set of candidate conservation measures before permutations are identified. The systems and methods can identify, in the set of candidate conservation measures as ordered according to the initial sequence, a subset of candidate conservation measures to be permuted. Identifying the permutations of the set of candidate conservation measures can comprise permuting those candidate conservation measures identified in the subset while preserving or maintaining the initial sequence for the other candidate conservation measures in the set. The initial sequence may be determined based on payback periods of the candidate conservation measures, capital expenditures of the candidate conservation measures, dependency of one of the candidate conservation measures on prior implementation of another of the candidate conservation measures, or some combination thereof. It will be appreciated that other methods for determining the initial sequence for the set of candidate conservation measures are also possible.

As part of analyzing implementation of the set of candidate conservation measures, the systems and methods of some embodiments can determine the interdependency between two or more candidate conservation measures based on the proposed sequence. For example, the systems and methods can determine the interdependency between two candidate conservation measures by calculating the difference in cost or use (e.g., capital cost or energy use) for implementing a first candidate conservation measure before a second candidate conservation measure, or implementing the first candidate conservation measure after the second candidate conservation measure.

According to some embodiments of the disclosed technology, a computer program product comprises code configured to cause a computer system to perform various operations described herein. Additionally, some embodiments may be implemented using a computer system as described herein.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a diagram illustrating an example architectural structure and example locations in the architectural structure where various conversation measures can be implemented in accordance with some embodiments of the technology described herein.

FIG. 2 is a diagram illustrating an example system for analyzing conservation measures in accordance with some embodiments of the technology disclosed herein.

FIG. 3 is a diagram illustrating an example system for analyzing conservation measures in accordance with some embodiments of the technology disclosed herein.

FIG. 4 a flowchart illustrating an example method for analyzing conservation measures in accordance with some embodiments of the technology disclosed herein.

FIG. 5 is diagram illustrating an example dataflow for a conservation analysis system in accordance with some embodiments of the technology disclosed herein.

FIG. 6 is a flowchart illustrating an example method for determining permutations of conservation measure sequences in accordance with some embodiments of the technology disclosed herein.

FIG. 7 illustrates an example of determining permutations of conservation measure sequences in accordance with some embodiments of the technology disclosed herein.

FIG. 8 illustrates an example of determining permutations of conservation measure sequences in accordance with some embodiments of the technology disclosed herein.

FIG. 9 illustrates an example computing module that may be used in implementing various features of embodiments of the disclosed technology.

The figures are not intended to be exhaustive or to limit inventions described herein to the precise form disclosed. It should be understood that any invention described herein can be practiced with modification and alteration, and that the disclosed technology be limited only by the claims and the equivalents thereof.

### DESCRIPTION OF EMBODIMENTS OF THE TECHNOLOGY

Various embodiments provide systems and methods that can be configured to analyze implementing one or more conservation measures (CMs) to an architectural structure (e.g., office buildings, bridges, parking structures, shopping centers, etc.), which can include proposing one or more sequences for implementing the conservation measures.

As described herein, a “conservation measure” can include an action, feature, or modification taken with respect to an architectural structure in order to reduce or alter usage or cost associated with a utility or other service and the architectural structure. Accordingly, one or more conservation measures can improve the performance or efficiency of an architectural structure and can bring a given architectural structure into compliance with particular building standards, certifications, and ratings. Building standards, certifications, and ratings could include green building certification and rating systems, such as, for example, Leadership in Energy & Environmental Design (LEED®) and Code for Sustainable Homes (CSH), and Estidama, and environmental impact rating systems, such as Building Research Establishment Environment Assessment Method (BREEAM), and Building and Construction Authority (BCA) GreenMark.

Before a set of conservation measures are applied to an architectural structure, some embodiments may assist in identifying which conservation measures to implement, determining benefits of implementing selected conservation measures, or planning implementation of selected conservation measures. For example, based on a set of constraints, embodiments may assist in sequencing implementation of selected conservation measures. Examples of constraints can include specifics regarding the architectural structure, duration of the retrofit plan, maximum capital expenditure per a given time period (e.g., week, month, year), incentives for implementations (e.g., time sensitive incentives, such as tax savings that expires after a certain year). Constraints can further include those associated with implementation of two or more conservation measures in a given time period (e.g., CM₁ and CM₂ cannot be implemented in the same year).

Those conservation measures selected for implementation may be part of a retrofit plan intended for an architectural structure to improve utility usage by that architectural structure. Use of certain embodiments can help in assessing risks of a retrofit plan, or determining the time, scope, budget, or quality of the retrofit plan. Generally, a retrofit plan can include a sequence of selected conservation measures to be implemented to an architectural structure over a period of time.

Particular embodiments can predict or project performance or impacts of a given retrofit plan according to net present value (NPV), capital expenditure, savings that can be achieved (e.g., with respect to utility usage or costs), time elapsed before value generated, magnitude of disruption to an architectural structure, end uses, and the like. For example, a user can review available conservation measures, select conservation measures for implementation (e.g., as part of a retrofit plan), review or modify parameters associated with selected conservation measures, generate different sequences for implementing the selected conservation measures, or review projected/predicted metrics regarding the performance or impact of different sequences. A user can review cumulative or annual utility cost savings, energy savings, water savings, or carbon savings as result of implementing selected conservation measures, and can assess the impact of implementing the various measures in varying sequences or orders of implementation. A user can also review the time elapsed before value generated, the magnitude of disruption by implementing selected conservation measures, impacts according to end uses (e.g., lighting, heating, and cooling), or financial implications. Performance or impact metrics can implementing a given retrofit plan can be divided according specified time intervals of implementation, such as by weeks, months or years. For instance, for every year of implementing a given retrofit plan, some embodiments can provide cumulative or annual energy saved, carbon saved, utility cost saved, capital expense, and net cash flow.

Accordingly, some embodiments can be incorporated into a tool that permits a user (e.g., a building designer or a building manager) to create, modify, or identify a retrofit plan for implementing one or more conservation measures, particularly one that is most sustainable or optimal (e.g., in terms of higher savings, lower cost). Such embodiments can sequence implementation of selected conservation measures within a retrofit plan, and compare costs, usage, or savings between different sequences generated, preferably to determine an optimal sequence of implementation. For those who decide on implementation of conservation measures, embodiments can facilitate retrofit planning in real time based on changing goals, without investing in conservation measures that fail in desired savings, and while achieving benefits with minimal upfront capital expenditure.

In some embodiments, a user may be permitted to modify the conservation measures available, including modifying parameters associated with the impact, performance, or implementation of conservation measures (e.g., options regarding a conservation measure).

For some embodiments, consider that there is a set of n conservation measures (CMs)—{CM₁, . . . CMₙ})—that a client selects to implement into an architectural structure over a duration of d years (i.e., {YR₁, . . . YR_{d}}). An optimum implementation plan can be one that realizes largest savings at the end of the three years while constraining annual cash flow (e.g., capital expenditures) as defined by the client. For a given year, annual cash flow out can be the difference between the cost of CMs implemented in the given year and the utility bill savings (or other savings) realized from the year preceding the given year (i.e., when such savings exists).

A sequence of conservation measures can comprise two or more CMs implemented over the duration of a plan. The rules for sequencing CMs can include: (1) any number of CMs can be implemented in a given year of the plan; (2) some CMs can be mutually exclusive (this implies that a given sequence can only contain some CMs and not others); (3) not all CMs need to be implemented; (4) if some CMs are implemented in the same year, their cumulative cost of implementation can be less than costs of implementing the ECMs individually.

Consider an example in which various embodiments are configured to sequence and analyze a sample set of six ECMs (i.e., {ECM₁, ECM₂, ECM₃, ECM₄, ECM₅, ECM₆}) that are to be implemented over three years (i.e., {YR₁, YR₂, YR₃}. Consider further that if ECM₂ is implemented in a given year, ECM₅ and ECM₆ cannot be implemented in that year, and that the cost of implementing ECM₄, ECM₅, and ECM₆ in the same year is less than implementing ECM₄, ECM₅, and ECM₆ in separate years (i.e., C({ECM₁,ECM₂,ECM₃})<Σᵢ₌₄⁶C(ECMᵢ)). Based on these parameters and constraints, some embodiments may sequence implementation of the set of six ECMs over the three years as follows: {YR₁:ECM₁ and ECM₂; YR₂:ECM₃; YR₃:ECM₄} (where ECM₅ and ECM₆ are excluded); {YR₁:ECM₁ and ECM₃; YR₂:ECM₄; YR₃:ECM₅ and ECM₆} (where ECM₂ is excluded); {YR₁:ECM₄, ECM₅ and ECM₆; YR₂:ECM₁; YR₃:ECM₃} (where ECM₂ is excluded and ECM₄; ECM₅ and ECM₆ are bundled); and {YR₁:ECM₅ and ECM₆; YR₂:ECM₆, ECM₁ and ECM₃; YR₃: —} (where YR3 is empty). As would be apparent to one of ordinary skill in the art after reading this description, other sequences are possible.

In various embodiments, the systems and methods can be configured to analyze the costs and the impact of each of these sequences and recommend an ideal sequence, or a set of preferred sequences, that present increased savings and lower cost of implementation. In some applications, annual (or other periodic) budgetary constraints can be entered and the system configured to arrange sequences while considering the cost of implementing the CMs as compared to available budget. Likewise, seasonal or other impacts could be considered when arranging the CM sequences.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any embodiment described herein, which are defined solely by the claims attached hereto.

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

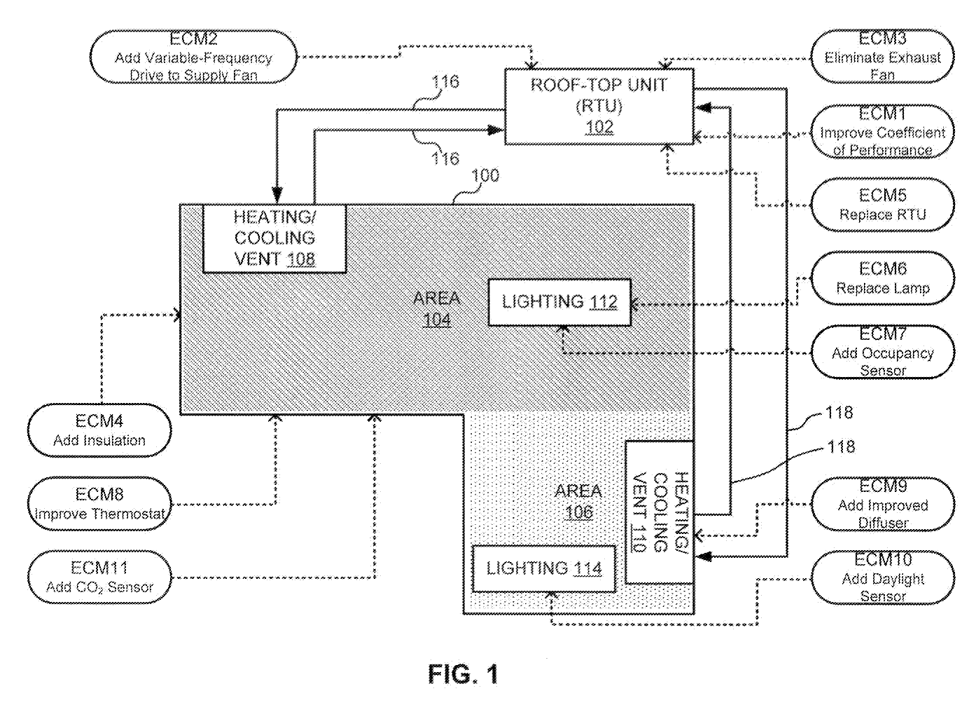

According to some embodiments, energy savings by an architectural structure can be computed according to areas. The architectural structure can be divided into a set of areas, whereby each area represents a central volume where end use energy is consumed. To illustrate, FIG. 1 represents an example architectural structure 100, a division of areas of the architectural structure 100, and locations in the architectural structure 100 where various ECMs can be implemented. As shown, the architectural structure 100 includes an area 104, which utilizes a heating/cooling vent 108 and a lighting unit 112, and an area 106, which utilizes a heating/cooling vent 110 and a lighting unit 114. Through air ducts 116 and 118, the heating/cooling vents 108 and 110 may be respectively coupled to a roof-top unit 102, which can provide heating, ventilation, and cooling (HVAC) functions for the architectural structure 100. FIG. 1 illustrates where energy conservation measures (ECMS) listed in the following table can be implemented with respect to the architectural structure 100.

TABLE 1

| CONSERVATION | |
|---|---|
| MEASURE | DESCRIPTION |
| ECM₁ | Improve Coefficient of |
| | Performance |
| ECM₂ | Add Variable-Frequency |
| | Drive to Supply Fan |
| ECM₃ | Eliminate Exhaust Fan |
| ECM₄ | Add Insulation |
| ECM₅ | Replace RTY |
| ECM₆ | Replace Lamp |
| ECM₇ | Add Occupancy Sensor |
| ECM₈ | Improve Thermostat |
| ECM₉ | Add Better Diffuser |
| ECM₁₀ | Add Daylight Sensor |
| ECM₁₁ | Add CO₂ Sensor |

As shown, ECM₁, ECM₂, ECM₃, and ECM₅ can be implemented to the RTU 102 for energy conservation. ECM₄, ECM₈, and ECM₁₁ can improve the HVAC characteristics for the area 104. ECM₆ and ECM₇ can be implemented to the lighting 112 for energy conservation. ECM₉ can be implemented to the heating/cooling vent 108 to improve HVAC characteristics for the area 106. ECM₁₀ can be implemented to the lighting 114 for energy conservation.

Various embodiments may analyze conservation measures according to different end uses, including one or more of space cooling, space heating, air distribution, water distribution, ventilation, and lighting, appliances. Space cooling can include the energy spent to meet the cooling load of a particular space. Space heating can include the energy expended to meet the heating load of a particular space. Air distribution can include energy expended in moving or recirculating air for a given area of space. Water distribution can include energy expended in moving or recirculating water for a given area of space. Ventilation can include energy spent in bringing in outside air in order to meet ventilation needs. The energy required to bring this air at the right temperature can be counted under heating and cooling. Lighting can include energy spent in maintaining required illumination in a given space. Appliances can include energy spent in keeping appliances operating.

The following table illustrates an example baseline resource consumption by an architectural structure, according to end uses, for existing components of the architectural structure before implementation of the ECMs. According to some embodiments, implementation of one or more of the ECMs listed in Table 1 can improve the end-use resource consumption of existing components over end use resource consumption listed in Table 2. It will be appreciated that in some embodiments, conservation measures could increase resource consumption according to one or more end uses while decreasing resource consumption according to one or more other end uses.

TABLE 2

| End Use | Electricity Use | Fuel Use |
|---|---|---|
| Space Cooling | 100 units | 0 units |
| Space Heating | 0 units | 150 units |
| Air Distribution | 50 units | 0 units |
| Lighting | 70 units | 0 units |
| Ventilation | 30 units | 30 units |

The following Equations 1 through 9 describe example calculations performed or considered by some embodiments during analysis of energy conservation measures (ECMs).

E(Aᵢ,uₖ,Fⱼ,t=0) Equation 1

In Equation 1, E represents energy use; Aᵢ represents the area of building structure, where i=1 . . . n; uₖ represents the end use energy consumption, where k=1 . . . m; Fⱼ, represents the fuel used, where j=1 . . . p; and t represents time in years such that t=0→q (e.g., 0 to duration of plan, q years).

ΔÊ(ECMₗ,Aᵢ,uₖ,Fⱼ)

In Equation 2, ΔÊ represents the normalized energy saved; ECMₗ represents each energy conservation measure; Aᵢ represents each area; uₖ represents each end use; and Fⱼ represents each fuel used.

Sequence S({ECMₗ}ₜ) Equation 3

In Equation 3, {ECMₗ}ₜ represents energy conservation measures implemented in year t; and t represents time in years such that t=0→q (e.g., 0 to duration of plan, q years).

Cost of Implementation C({ECMₗ}ₜ) Equation 4

Cost of Fuel C(Fⱼ) per a unit of fuel Equation 5

For some embodiments, analyzing a Sequence S of ECMs can involve calculating: (1) total energy saving as a result of the Sequence S; and (2) cash flow out after each year assuming utility bill savings are re-invested in implementing energy conservation measures that following the Sequence S.

For t=1 . . . q, an embodiment may calculate the following Equations 6-8 during operation.

Ê(Aᵢ,uₖ,Fⱼ,{ECMₗ})=(1−ΔÊ(ECM₁))×(1−ΔÊ(ECM₂)) . . . (1−ΔÊ(ECM_{q})) for each Aᵢ,uₖ, and Fⱼ; Equation 6

ΔE(Aᵢ,uₖ,Fⱼt=t+1)=(1−ΔÊ)E(Aᵢ,uₖ,Fⱼ,t=t}) Equation 7

Cash Flow(t=t+1)=Cost({ECMₗ}ₜ₌ₜ)−[C_{q}E_{q,t+1}−C_{q}E_{q,t}] Equation 8

For some embodiments, energy savings can be calculated according to the following Equation 9.

$${\sum }_{i = 1}^{n} {\sum }_{j = 1}^{m} {\sum }_{k = 1}^{p} E ( {A}_{i} , {u}_{k} , {F}_{j} , t = plan duration ) - {\sum }_{i = 1}^{n} {\sum }_{j = 1}^{m} {\sum }_{k = 1}^{p} E ( {A}_{i} , {u}_{k} , {F}_{j} , t = 0 ) \qquad Equation 9$$

The following provides an example mathematical representation of a sequence of energy conservation measures in accordance with some embodiments. Assuming a set of n ECMs to be implemented in an m-year plan, a sequence S can be represented by an m×n matrix, as shown below, and a third dimension k equal to the number of areas of an architectural structure.

TABLE 3

| | ECM₁ | ECM₂ | . . . | . . . | ECM₍ₙ₋₁₎ | ECMn |
|---|---|---|---|---|---|---|
| YR₁ | s₁₁ | s₁₂ | . . . | . . . | s₁₍ₙ₋₁₎ | s₁ₙ |
| YR₂ | s₂₁ | s₂₂ | . . . | . . . | s₂₍ₙ₋₁₎ | s₂ₙ |
| . | . | . | . | | . | . |
| . | . | . | | . | . | . |
| . | . | . | | | s₍ₘ₋₁₎₍ₙ₋₁₎ | s₍ₘ₋₁₎ₙ |
| YRₘ | sₘ₁ | sₘ₂ | . . . | . . . | sₘ₍ₙ₋₁₎ | sₘₙ |

With respect to sequence S, if sᵢⱼₖ is set to 0, ECMⱼ is not implemented in year i for area k. On the other hand, sᵢⱼₖ is set to 1 if ECMⱼ is implemented in year i for area k.

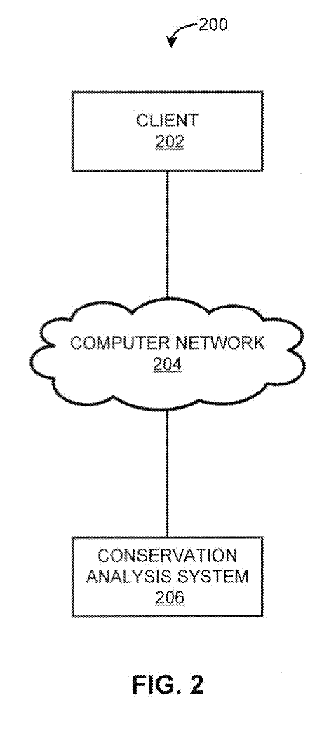

FIG. 2 is a block diagram illustrating an example system for analyzing conservation measures in accordance with some embodiments of the technology disclosed herein. In particular, FIG. 2 illustrates an example environment 200 that includes a client 202, a conservation analysis system 206, and a computer network 204 configured to facilitate data communication between the client 202 and the conservation analysis system 206. Each of the client 202 and the conservation analysis system 206 can respectively be implemented using one or more separate computer systems. For example, while the client 202 may be implemented in a user-oriented computer system, such as a desktop computing device or a mobile computing device (e.g., smartphone, tablet, and laptop), the conservation analysis system 206 can be implemented on one or more server computing system, such as those generally used in providing cloud-based computing services. Those skilled in the art will appreciate that for some embodiments, the client 202 and the conservation analysis system 206 can be implemented as one or more processes operating on a single computer system without need of such a network as the computer network 204.

Through the client 202, a user, such as a building conservation designer or facilities manager, can access services, features, and functionality provided by the conservation analysis system 206 in accordance with some embodiments. For instance, by way of a web-based interface or an application program interface (API), the client 202 can access the ability of the conservation analysis system 206 to propose a sequence for implementing two or more conservation measures to an architectural structure, and to analyze such an implementation, in accordance with user-defined constraints (e.g., duration of implementation or cash flow limitations).

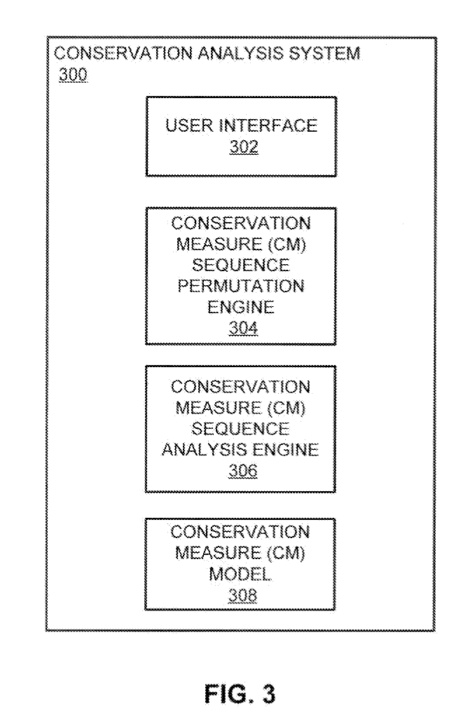

FIG. 3 is a block diagram illustrating an example system 300 for analyzing conservation measures in accordance with some embodiments of the technology disclosed herein. As shown by FIG. 3, the conservation analysis system 300 comprises a user interface 302, a conservation measure (CM) sequence permutation engine 304, a conservation measure (CM) sequence analysis engine 306, and a conservation measure (CM) model 308. For some embodiments, the conservation analysis system 300 may be similar to the conservation analysis system 206 of FIG. 2.

The user interface 302 may be configured to provide a client (e.g., the client 202) with user access to services, features, and functionalities available through the conservation analysis system 300 in accordance with some embodiments. As described herein, the user interface 302 can provide user access in a variety of ways, including by web-based interfaces and by application program interfaces (APIs). Through the user interface 302, a user can enter constraints to be considered during analysis of conservation measures by the conservation analysis system 300 with respect to a given architectural structure. The user interface 302 can be used to enter baseline information regarding utility costs expended by the given architectural structure according to two or more end uses. An example of baseline information that can be entered through the user interface 302 can include the following table.

TABLE 4

| End Use | Cost |
|---|---|
| AHU Air Distribution | $280,915 |
| Cooling Air Distributed | $282,273 |
| Heating Air Distributed (Gas) | $71,727 |
| Heating Air Distributed | $97 |
| (Electric) | |
| Auxiliary Equipment (Electric) | $97 |
| Electric Radiant Panel Heating | $23,592 |
| Electricity Generation | $485,102 |
| Gas Consumption | $27 |
| Back of House | $49,454 |
| Mall Lighting | $141,120 |
| Roof Lights | $3,185 |
| Road Lighting | $49,758 |
| Landscape Lighting | $4,581 |
| Service Yard | $37,266 |
| Surface CP | $29,712 |
| MSCP | $249,486 |
| Bus Station | $4,831 |
| 3^{rd} Party Retailers | $31,858 |
| Escalators | $74,883 |
| DHW | $27,811 |
| CWS | $22,824 |
| External Pumps | $29,416 |

The user interface 302 can also permit a user to enter data regarding conservation measures to be sequenced and analyzed for the given architectural structure. For example, through the user interface 302, information regarding savings achieved by each conservation measure can be entered by a user, whereby the savings can be defined according to impact to each end use. Other examples of conservation measure information that can be entered through the user interface 302 can include the following the initial cost of implementing each conservation measure to be considered.

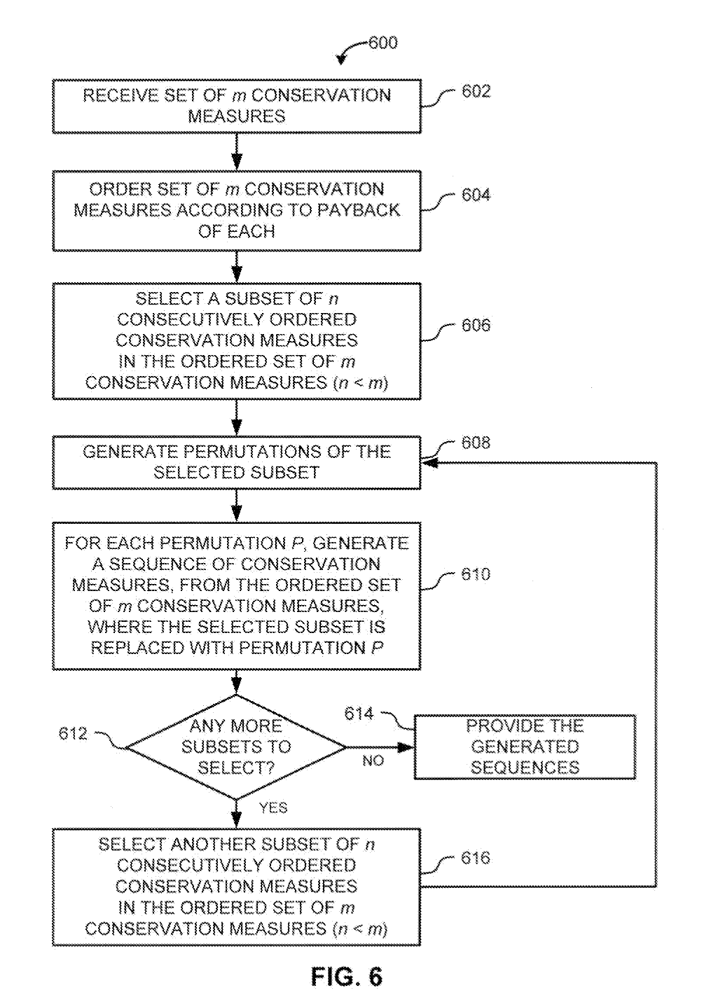

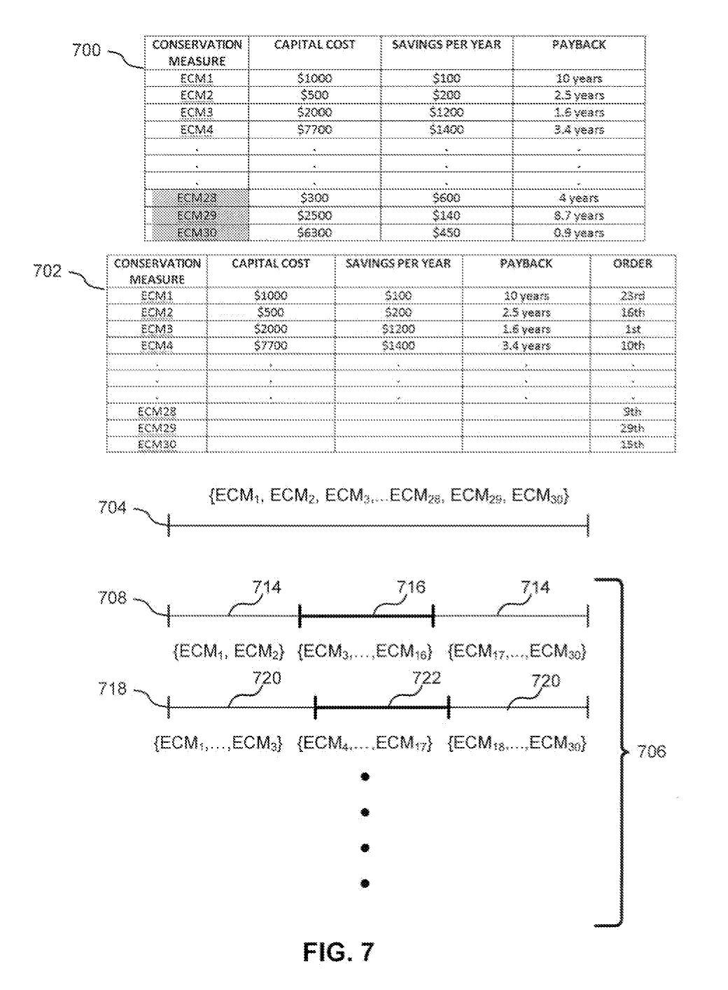

The CM sequence permutation engine 304 may be configured to generate or otherwise identify permutations of CM sequences to be analyzed by the conservation analysis system 300 when attempting to identify a sequence of CMs that meets a user's expectations. The sequence of CMs identified by the conservation analysis system 300 can be the optimal or close-to-optimal sequence of CMs that satisfies a user's constraints, such as duration of implementation, capital expenditure per a time period (e.g., per a year), implementation restrictions between CMs, and the like. For some embodiments, the CM sequence permutation engine 304 can generate every permutation possible for m CMs (i.e., m! possible permutations). Where the number of CM sequences to be considered by the conservation analysis system 300 is large, the number of CM sequences can be reduced to a smaller set of CM sequences than all possible permutations of CM sequences. In accordance with some embodiments, the smaller set of CM sequences may be determined in accordance with FIG. 6 or FIG. 7 as described herein.

The CM sequence analysis engine 306 may be configured to analyze the each sequence of CMs generated by the CM sequence permutation engine 304. According to some embodiments, the CM sequence analysis engine 306 may analyze each sequence of CMs according to the following process.

Assume the CM sequence permutation engine 304 generates a set SEQ of CM sequences, where the conservation measures are to be implemented to a given architectural structure, that each sequence seqⱼ in SEQ is implemented over a time period T, that each time interval tₖ of time period T has a max negative cash flow cf_{max,k}, and that cost savings savₖ achieved at the end of a given time interval tₖ can benefit (i.e., increases) the max negative cash flow cf_{max,k+1} for the next time interval interval tₖ₊₁ (i.e., cf_{max,k+1}=cf_{max,k+1}+savₖ). Also assume that the algorithm begins by obtaining a set C_{baseline} of baseline costs c_{baseline,l} of operating existing components of a given architectural structure, possibly according to end uses.

```
For each seqⱼ in set SEQ of sequences of conservation measures, where the
conservation measures are to be implemented to a given architectural
structure
  For each time interval tₖ in time period T
    Determine max negative cash flow cf_{max,k} for tₖ (e.g., accounting
    for any savings savₖ₋₁ from the preceding time interval tₖ₋₁)
    For each conservation measure CMᵢ in seqⱼ sequence
      Analyze initial cost c_{init,i} of implementing CMᵢ with respect
      to the given architectural structure
      If c_{init,l} > current negative cash flow cfₖ for tₖ, then go to
      next time interval tₖ₊₁
      Implement CMᵢ to the given architectural structure
      Update current negative cash flow cfₖ for tₖ with the initial
      cost c_{init,i} of implementing CMᵢ
      Analyze savings achieved by implementing CMᵢ with
      respect to the given architectural structure
      Determine impact of CMᵢ to the set C_{baseline} of baseline
      costs of the given architectural structure
    End For
    Determine cost savings savₖ achieved at the end of a given time
    interval tₖ by the implemented CMs
  End For
  Determine overall savings savₒᵥₑᵣₐₗₗ of implementing seqⱼ of conservation
  measures over time period T
End For
```

The CM model 308 may be configured to provide the CM sequence analysis engine 306 with information regarding conservation measures being analyzed by the CM sequence analysis engine 306. For example, the CM model 308 may provide capital costs (e.g., initial cost) for each conservation measure to be implemented with respect to a given architectural structure, savings achieved for the given architectural structure by each conservation measure to be implemented, information regarding the impact of each conservation measure on one or more end uses of the given architectural structure. Using information provided by the CM model 308, the impacts of conservation measures on the given architectural structure can be according to baseline cost or utility usage of the given architectural structure. For some embodiments, information regarding capital costs, end use impacts, and savings associated with a particular conservation measure can be generalized/standardized for conservation analysis purposes. For example, costs, impacts, and savings of a conservation measure can be applied according to according to square footage or volume of an architectural structure irrespective of other specifics of the architectural structure (e.g., geometry, construction materials, construction type). For some embodiments, information regarding capital costs, end use impacts, and savings associated with a particular conservation measure can be specific to an architectural structure, and account for such aspects of the architectural structure as geometry, existing features, construction material, and like. For example, information regarding capital costs, end use impacts, and savings associated with a conservation measure can comprise a static dataset, which may be manually inputted by a user (e.g., through the user interface 302) or generated based on analysis of the particular architectural structure. Alternatively, the CM model 308 may generate dynamic information regarding particular conservation measures as those particular conservation measures are implemented to the particular architectural structure.

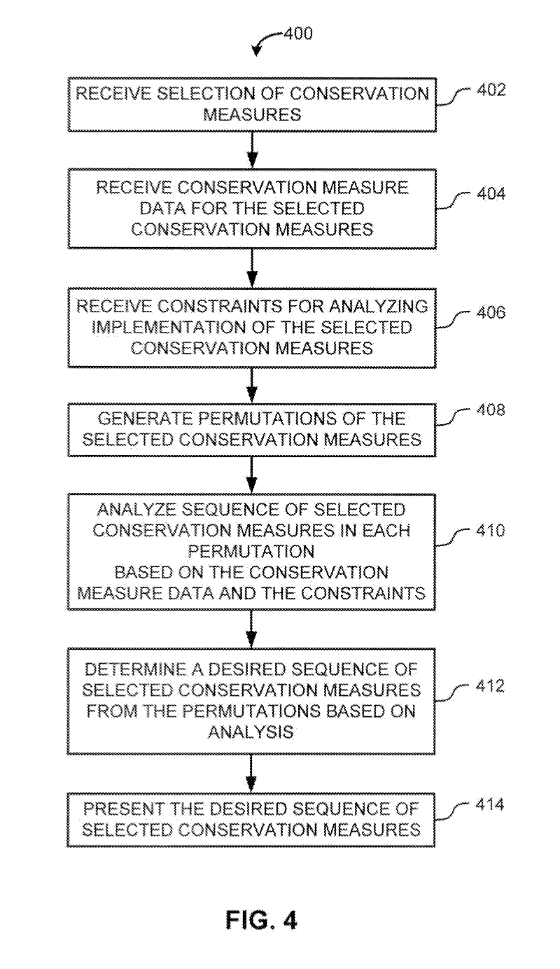

FIG. 4 is a flowchart illustrating an example method 400 for analyzing conservation measures in accordance with some embodiments of the technology disclosed herein. The method 400 may begin at operation 402, by receiving a selection of conservation measures to be implemented to a given architectural structure. For some embodiments, the selection of conservation measures may be received through a user interface similar to the user interface 302. At operation 404, the method 400 may receive conservation measure data for the selection conservation measures. For various embodiments, the conservation measure data may comprise information regarding capital costs, end use impacts, and savings associated with the conservation measures selected during operation 402. The data received may be generalized or specific with respect to the given architectural structure being analyzed.

At operation 406, the method 400 may receive constraints for analyzing implementation of the selected conservation measures with respect to the given architectural structure. At operation 408, the method 400 may generate permutations of the selected conservation measures. As noted herein, the permutations may be generated in accordance with FIG. 6 or FIG. 7 as described herein.

At operation 410, the method 400 may analyze the sequence of selected conservation measures in each permutation based on the conservation measures data and the constraints. Operation 408 may analyze each sequence of selected conservation measures with respect to the given architectural structure. For some embodiments, the sequence of selected conservation measures in each permutation may be analyzed in accordance with the algorithm described with respect to FIG. 3, and in particular with respect to the CM sequence analysis engine 306.

At operation 412, the method 400 may determine a desired sequence of selected conservation measures from the permutations of operation 408 based on the analysis of operation 410. The desired sequence of selected conservation measures may be one that is optimal or close to optimal sequence with respect to capital expenditure for selected conservation measures, NPV, savings achieved from selected conservation measures, user defined constraints, or the like.

At operation 414, the method 400 presents the desired sequence of selected conservation measures to the user for review or manual modification.

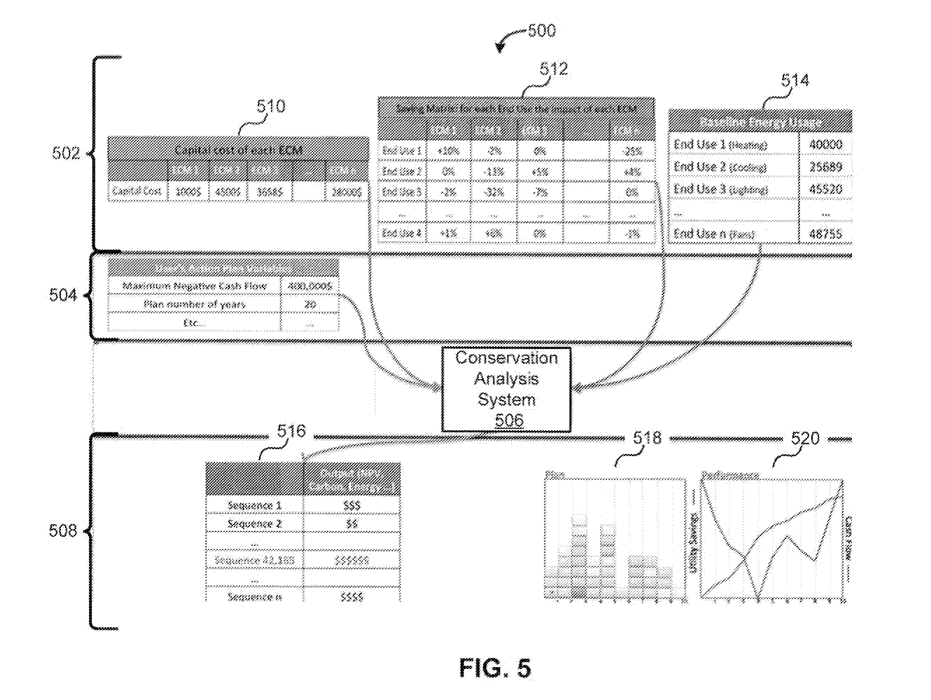

FIG. 5 is a chart illustrating an example dataflow 500 for a conservation analysis system in accordance with some embodiments of the technology disclosed herein. As shown in the data flow 500, data 502 may be received relating to an architectural structure for which conservation measures (e.g., ECMs) will be analyzed, or relating to conservation measures that may be implemented to the architectural structure. Examples of data relating to conservation measures can include, without limitation, a capital cost matrix 510 for implementing conservation measures to the architectural structure, and a savings impact matrix 512 for conservation measures according to end use. When analyzing the implementation of selected conservation measures with respect to the architectural structure, the capital cost matrix 510, the savings impact matrix 512, or both, may be utilized in determining interdependencies between two or more ECMs when implemented in a particular sequence. For instance, the savings impact matrix 512 may be utilized to calculate the difference in energy use between, for example, implementing ECM1 before is implemented ECM2 with respect to the architectural structure, or implementing ECM1 after ECM2 is implemented with respect to the architectural structure. In another example, depending on the sequence in which the ECMs are implemented with respect to the architectural structure, the capital cost matrix 510 can be utilized to determine potential capital cost increases or decreases with respect to individual ECMs. For example, implementing ECM1 may be 20% less expensive if ECM1 is implemented after ECM2.

An example of data relating to the architectural structure can include, without limitation, a baseline energy use matrix 514 by the architectural structure, possibly according to end use. Certain data may, in some embodiments, be received, stored or entered as data tables or matrices, which may be persistently stored on database system. Depending on the embodiment, data 502 relating to the architectural structure or conservation measures may be generated or otherwise obtained by way of a computer-implemented process, manual user entry through a computer system (e.g., through a spreadsheet), or some combination thereof. For instance, the data relating to the architectural structure may be obtained through a computer-based process that analyzes data relating to a three-dimensional representation of the architectural structure.

As also shown in in the data flow 500, data 504 may be received relating to one or more constraints for analyzing implementation of selected conservation measures with respect to the architectural structure. In some embodiments, the constraints can be referred to as action plan variables of a user wishing to analyze implementation of conservation measures to the architectural structure. Depending on the embodiment, data 504 relating to the constraints may be generated or otherwise obtained by way of a computer-implemented process, manual user entry through a computer system, or some combination thereof.

A conservation analysis system 506 may receive or otherwise obtain the data 502 and 504 and analyze implementation of conservation measures with respect to the architectural structure in accordance with various embodiments described herein. As discussed herein, the conservation analysis system 506 may utilize the capital cost matrix 510, the savings impact matrix 512, or both, to determine interdependencies between two or more ECMs when implemented in a particular sequence. The conservation analysis system 506 may, for example, be similar in composition or operation to the conservation analysis system 300 described with respect to FIG. 3. The conservation analysis system 506 may identify permutations of a set of candidate conservation measures for the architectural structure, with each of the permutations proposing a sequence for implementing the set of candidate conservation measures to the architectural structure. The conservation analysis system 506 may further analyze implementation of the set of candidate conservation measures according to a sequence of at least one of the permutations. The conservation analysis system 506 may perform analysis based one or more of: the data 502 as it relates to the architectural structure; the data 502 as it relates to conservation measures that may be implemented to the architectural structure; or the data 504 as it relates to one or more constraints for analyzing implementation of selected conservation measures with respect to the architectural structure. Based on the resulting analysis, the conservation analysis system 506 may determine a proposed sequence for implementing the set of candidate conservation measures to the architectural structure.

During operation, the conservation analysis system 506 may generate output data 508 regarding sequencing of implementation of conservation measures to the architectural structure. The output data 508 may include raw output data 516 generated for each sequence of implementing conservation measures to the architectural structure. The output data 508 may also include post-processed data displayed in the form of charts 518 and 520. The post-processed data can be based on the raw output data 516 produced by the conservation analysis system 506.

FIG. 6 is a flowchart illustrating an example method 600 for determining permutations of conservation measure sequences in accordance with some embodiments of the technology disclosed herein. The method 600 may be performed by a conservation analysis system, such as by the CM sequence permutation engine 304 of the conservation analysis system 300. At operation 602, the method 600 may receive a set of m conservation measures, which may have been selected by a user for implementation with respect to a given architectural structure. At operation 604, the method 600 may order the set of m conservation measures according to payback of each conservation measure. For some embodiments, payback for a given conservation measure can be calculated as the number of years for a conservation measure to payback its capital cost. For instance, payback for a conservation measure (CM) may be calculated as follows:

$$\frac{capital cost for implementing the CM}{savings per a year achieved by the C M} = payback ( years )$$

At operation 606, the method 600 may select a subset, preferably a proper subset, of n consecutively ordered conservation measures in the ordered set of m conservation measures (where n<m). The method 600 may continue by generating permutation of the selected subset at operation 608. At operation 610, for each permutation P generated during operation 608, the method 600 may generate a sequence of conservation measures, from the ordered set of m conservation measures, where the selected subset is replaced with permutation P.

At decision point 612, the method 600 determines whether there any more possible subsets in the order set of m conservation measures that can be processed by the method 600. If no further subsets remain to be processed by method 600, at operation 614, the method 600 may provide the generated sequences during operation 610. For some embodiments, the generated sequences may be provided to a conservation analysis system, such as the Cm sequence analysis engine 306 of the conservation analysis system 300.

If further subsets remain to be processed by method 600, at operation 616, the method 600 may selected another subset of n consecutively ordered conservation measured in the ordered set of m conservation measures. Subsequent to operation 616, the method 600 may continue return to operation 608 to generate permutations of the selected subset.

FIG. 7 illustrates an example 700 of determining permutations of conservation measure sequences in accordance with some embodiments of the technology disclosed herein. In the example shown in FIG. 7, table 700 presents thirty ECMs from which a user may select to implement with respect to an architecture structure. Included in the table 700 are capital cost for each ECM, yearly savings realized through implementation of each ECM, and the time period for payback for each ECM. The thirty ECMs in the table 700 may be permuted to generate sequences of ECMs in accordance with some embodiments. Table 702 is similar to the table 700 and includes an order column defining a sequence for implementing conservation measures as proposed by a permutation.

If every permutation of the thirty ECMs were to be considered, 30! unique sequences of ECMs would be considered, which is equal to 2.65×10³² sequences. Given the large number sequences (30! sequences) to be considered, certain embodiments may consider a smaller subset of possible ECM sequences (i.e., <30! ECM sequences), possibly to speed up analysis of conservation measure sequences or to make computation of the same more practical. Various embodiments may determine the smaller subset of possible ECM sequences in accordance with FIG. 6. As discussed herein, payback for a given conservation measure (e.g., ECM) can be calculated as the number of years for a conservation measure to payback its capital cost. For instance, payback for a conservation measure (CM) may be calculated as follows:

$$[ \frac{capital cost for implementing the CM}{savings per a year achieved by the C M} = payback ( years ) .$$

As shown in FIG. 7, some embodiments may begin with a initial sequence 704 (hereafter, referred to as “the baseline sequence 704”) for implementing a set of energy conservation measures {ECM₁-ECM₃₀} to the architectural structure. For illustrative purposes, it will be assumed that the conservation measures in the baseline sequence 704 are sequenced according to numerical reference of the ECM. It will be understood however that in some embodiments, the baseline sequence 704 may sequence implementation of a conservation measures to the architectural structure according to one or more attributes of the conservation measures including, for example, the payback of the conservation measure.

Upon identifying the baseline sequence 704, various embodiments may identify, based on the baseline sequence 704, one or more permutations 706 for implementing the set of energy conservation measures, where each permutation proposes a sequence of implementing the conservation measures different from the baseline sequence 704. For example, at least one sequence 708 included in permutations 706 may be generated, from the baseline sequence 704, such that: the sequence 708 sequences a subset of 714 of energy conservation measures identified in the baseline sequence 704 (e.g., {ECM₁, ECM₂, ECM₁₇, . . . , ECM₃₀}) according to the baseline sequence 704; and the sequence 708 sequences a subset 716 of the remaining energy conservation measures identified in the baseline sequence 704 (e.g., {ECM₃, . . . , ECM₁₆}) differently from (e.g., permuted in comparison to) the baseline sequence 704. According to some embodiments, the sequence 708 may be generated by: identifying, in the set of energy conservation measures as ordered according to the baseline sequence 704, a subset 716 of conservation measures to be permuted; and identifying permutations of the conservation measures by permuting those candidate conservation measures identified in the subset 716 while preserving the baseline sequence 704 for the other conservation measures identified in the subset 714 (where the conservation measures identified in the subset 716 are mutually exclusive from the those identified in the subset 714).

It will be understood that other sequences may be included in the permutations 706, such as sequence 718, which may be generated by identifying a another subset 722 of conservation measures, different from subset 716, (e.g., {ECM₁, ECM₃, ECM₁₈, . . . , ECM₃₀}) and permuting those conservation measures identified in the subset 722 (e.g., {ECM₄, . . . , ECM₁₇}) while preserving the baseline sequence 704 for the remaining conservation measures identified in the subset 720. It will also be understood that in some embodiments, the subset of conservation measures identified for permutation (e.g., 716 and 722) may be a contiguous series of conservation measures as sequenced according a baseline sequence (e.g., 704), or a non-contiguous series of conservation measures. The size of the subset identified or the number of permutations identified may depend on the number of factors including, without limitations, user preferences, computing resources (e.g., what is available or required), and estimated processing time.

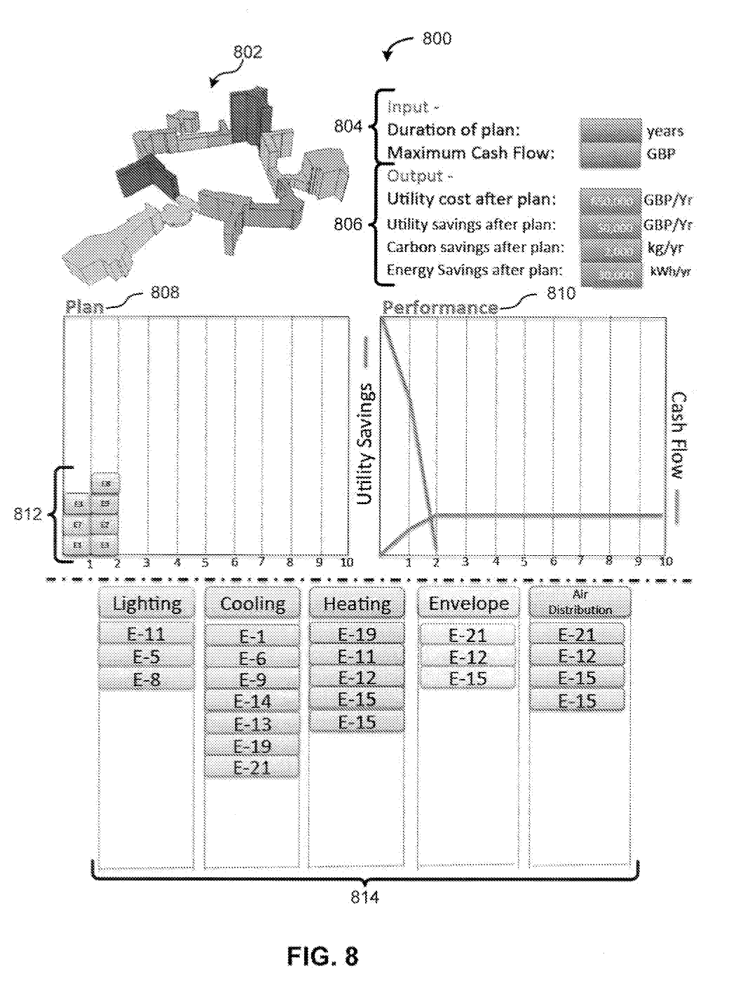

FIG. 8 illustrates an example graphical interface 800 by which a user can access a system in accordance with some embodiments of the technology disclosed herein. As shown in FIG. 8, the graphical interface 800 may include a representation 802 of the architectural structure for which conservation measures are being implemented or analyzed, user inputs 804, analysis outputs 806, a proposed plan 808 for implementing a sequence of selected conservation measures, projected performance 810 for the proposed plan, and available conservation measures 814. In the user inputs 804, a user can define a time period (e.g., duration in years) for implementing two or more conservation measures of a retrofit plan with respect to a given architectural structure, and can defined a maximum negative cash flow for each interval of the defined time period (e.g., for each year) of the proposed plan. In analysis outputs 806, embodiments can provide projected impacts or performance of a given architectural structure after a proposed plan has been implemented. The analysis outputs 806 can include utility cost, utility savings after plan, carbon savings, and energy savings after implementation of the proposed plan. The proposed plan 808 can visually illustrate conservation measures 812 selected for implementation by the current proposed plan as blocks, and can visually illustrate the sequence of implementing the selected measures according to the specific intervals (e.g., years) of the proposed plan. For some embodiments, a user can modify the proposed plan presented by adding or removing conservation measure to and from the proposed plan 808.

The projected performance 810 visually illustrates the performance by the proposed plan 808 according to utility savings or cash flow achieved. As conservation measures are added and removed from the proposed plan 808, or the sequence of implementing conservation measures in the proposed plan 808 is modified, the performance or impacts provided by the analysis output 806 or the projected performance 810 may change accordingly, preferably in or near real-time.

The available conservation measures 814 may visually provide a listing of conservation measures available for implementation with respect to the given architectural structure. The listing of conservation measures may be provided according to various categories or end uses, such as lighting, cooling, heating, envelope, or air distribution.

For some embodiments, conservation measures can be added to or removed from the proposed plan 808 by way of dragging-and-dropping blocks between the available conservation measures 814 and the proposed plan 808. Likewise, modifying the implementation sequence of selected conservation measures 812 in the proposed plan 808 can be facilitated by way of dragging-and-dropping blocks within the proposed plan 808.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

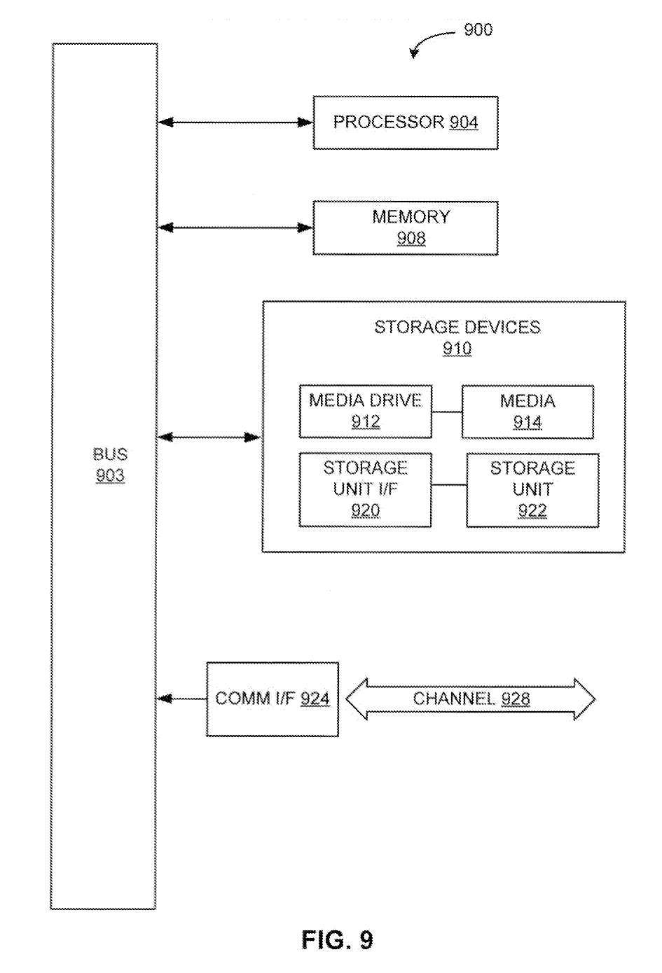

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the technology are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 900. After reading this description, it will become apparent to a person skilled in the relevant art how to implement the technology using other computing modules or architectures.

Referring now to FIG. 9, computing module 900 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 900 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 900 might include, for example, one or more processors, controllers, control modules, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of computing module 900 or to communicate externally.

Computing module 900 might also include one or more memory modules, simply referred to herein as main memory 908. For example, preferably random access memory (RAM) or other dynamic memory, might be used for storing information and instructions to be executed by processor 904. Main memory 908 might also be used for storing temporary variables or other intermediate information during execution of instructions to be executed by processor 904. Computing module 900 might likewise include a read only memory (“ROM”) or other static storage device coupled to bus 902 for storing static information and instructions for processor 904.

The computing module 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a floppy disk drive, a magnetic tape drive, an optical disk drive, a CD or DVD drive (R or RW), or other removable or fixed media drive might be provided. Accordingly, storage media 914 might include, for example, a hard disk, a floppy disk, magnetic tape, cartridge, optical disk, a CD or DVD, or other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing module 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory module) and memory slot, a PCMCIA slot and card, and other fixed or removable storage units 922 and interfaces 920 that allow software and data to be transferred from the storage unit 922 to computing module 900.

Computing module 900 might also include a communications interface 924. Communications interface 924 might be used to allow software and data to be transferred between computing module 900 and external devices. Examples of communications interface 924 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 924 might typically be carried on signals, which can be electronic, electromagnetic (which includes optical) or other signals capable of being exchanged by a given communications interface 924. These signals might be provided to communications interface 924 via a channel 928. This channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 900 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for analyzing conservation measures, comprising:
a computer system identifying permutations of a set of candidate conservation measures for an architectural structure, wherein each of the permutations proposes a sequence for implementing the set of candidate conservation measures to the architectural structure;
the computer system analyzing implementation of the set of candidate conservation measures according to a particular sequence of at least one of the permutations; and
the computer system determining a proposed sequence for implementing the set of candidate conservation measures to the architectural structure, wherein the proposed sequence is determined based at least on analyzing implementation of the set of candidate conservation measures according to the particular sequence.

2. The method of claim 1, further comprising the computer system receiving conservation measure data for analyzing implementation of the set of candidate conservation measures.

3. The method of claim 1, further comprising the computer system receiving a constraint for analyzing implementation of the set of candidate conservation measures.

4. The method of claim 1, wherein analyzing implementation of the set of candidate conservation measures is based on conservation measure data.

5. The method of claim 1, wherein analyzing implementation of the set of candidate conservation measures is based on a constraint.

6. The method of claim 1, further comprising the computer system presenting the proposed sequence for implementing the set of candidate conservation measures to the architectural structure.

7. The method of claim 1, further comprising the computer system receiving a selection of the set of candidate conservation measures.

8. The method of claim 1, further comprising:
the computer system determining an initial sequence for implementing the set of candidate conservation measures; and
the computer system identifying, in the set of candidate conservation measures as ordered according to the initial sequence, a subset of candidate conservation measures to be permuted, wherein identifying the permutations of the set of candidate conservation measures comprises permuting those candidate conservation measures identified in the subset while preserving the initial sequence for the other candidate conservation measures in the set.

9. The method of claim 8, wherein the initial sequence is determined based on payback periods of the candidate conservation measures.

10. The method of claim 8, wherein the initial sequence is determined based on capital expenditures of the candidate conservation measures.

11. The method of claim 8, wherein the initial sequence is determined based on a dependency of one of the candidate conservation measures on prior implementation of another of the candidate conservation measures.

12. The method of claim 1, wherein analyzing implementation of the set of candidate conservation measures comprises the computer system determining the interdependency between two or more energy candidate conservation measures based on the particular sequence.

13. A computer program product embedded on non-transitory computer storage media, which when executed by a computer, causes the computer to implement a method for analyzing conservation measures, the computer program product comprising:
code for identifying permutations of a set of candidate conservation measures for an architectural structure, wherein each of the permutations proposes a sequence for implementing the set of candidate conservation measures to the architectural structure;
code for analyzing implementation of the set of candidate conservation measures according to a particular sequence of at least one of the permutations; and
code for determining a proposed sequence for implementing the set of candidate conservation measures to the architectural structure, wherein the proposed sequence is determined based at least on analyzing implementation of the set of candidate conservation measures according to the particular sequence.

14. The computer program product of claim 13, further comprising code for receiving conservation measure data for analyzing implementation of the set of candidate conservation measures.

15. The computer program product of claim 13, further comprising code for receiving a constraint for analyzing implementation of the set of candidate conservation measures.

16. The computer program product of claim 13, wherein analyzing implementation of the set of candidate conservation measures is based on conservation measure data.

17. The computer program product of claim 13, wherein analyzing implementation of the set of candidate conservation measures is based on a constraint.

18. The computer program product of claim 13, further comprising code for presenting the proposed sequence for implementing the set of candidate conservation measures to the architectural structure.

19. The computer program product of claim 13, further comprising code for receiving a selection of the set of candidate conservation measures.

20. The computer program product of claim 13, further comprising:
code for determining an initial sequence for implementing the set of candidate conservation measures; and
code for identifying, in the set of candidate conservation measures as ordered according to the initial sequence, a subset of candidate conservation measures to be permuted, wherein identifying the permutations of the set of candidate conservation measures comprises permuting those candidate conservation measures identified in the subset while preserving the initial sequence for the other candidate conservation measures in the set.

21. The computer program product of claim 20, wherein the initial sequence is determined based on payback periods of the candidate conservation measures.

22. The computer program product of claim 20, wherein the initial sequence is determined based on capital expenditures of the candidate conservation measures.

23. The computer program product of claim 20, wherein the initial sequence is determined based on a dependency of one of the candidate conservation measures on prior implementation of another of the candidate conservation measures.

24. The computer program product of claim 13, wherein the code for analyzing implementation of the set of candidate conservation measures comprises code for determining the interdependency between two or more candidate conservation measures based on the particular sequence.

25. A computer system comprising:
at least one processor; and
a memory storing instructions configured to instruct the at least one processor to perform:
identifying permutations of a set of candidate conservation measures for an architectural structure, wherein each of the permutations proposes a sequence for implementing the set of candidate conservation measures to the architectural structure;
analyzing implementation of the set of candidate conservation measures according to a particular sequence of at least one of the permutations; and
determining a proposed sequence for implementing the set of candidate conservation measures to the architectural structure, wherein the proposed sequence is determined based at least on analyzing implementation of the set of candidate conservation measures according to the particular sequence.
